(19) United States
(12) Patent Application Publication
(10) Pub. No.: US 2013/0147260 A1
(43) Pub. Date: Jun. 13, 2013

(54) Method for Controlling the Pressure in an Electronically Controlled Hydraulic Brake System for a Motor Vehicle

(71) Applicant: Mirco Loos, Rodgau (DE)

(72) Inventor: Mirco Loos, Rodgau (DE)

(73) Assignee: Continental Teve AG & Co. oHG, Frankfurt (DE)

(21) Appl. No.: 13/700,332

(22) PCT Filed: May 19, 2011
(86) PCT No.: PCT/EP2011/058205

§ 371 Date: Jan. 28, 2013

(30) Foreign Application Priority Data
May 27, 2010 (DE) 10 2010 029 384.9

(51) Int. Cl. B60T 13/68

(52) U.S. Cl. CPC B60T 13/686
USPC 303/20

(57) ABSTRACT

A method for controlling the pressure in a hydraulic system in an electronically regulated motor vehicle brake system, including controlling the pressure using an analogized solenoid valve, and controlling the valve such that it moves into a partially open state, modulating the coil current (I) of the valve by alternation between a first (I₁) and a second current value (I₂). The solenoid valve held in the closed state by means of a coil current (I) corresponding to the first current value (I₁). A third current value (I₃) is provided for the coil current which lies between the first and second current values (I₁, I₂) and, during energization phases (Tₚ₁, Tₚ₁, Tₚ₁) of the solenoid valve. The coil current (I) is modulated by alternation between the second current value (I₂) and the third current value (I₃) with the amplitude (A) predefined by the third current value (I₃) and a predefined frequency.

### CROSS-REFERENCE TO RELATED APPLICATIONS

This application claims priority to German Patent Application No. 10 2010 029 384.9, filed May 27, 2010 and PCT/EP2011/058205, filed May 19, 2011.

### FIELD OF THE INVENTION

The invention relates to a method for controlling the pressure in a hydraulic system, in particular in an electronically regulated brake system for a motor vehicle, in which method the pressure or the pressure profile is controlled and/or regulated by means of at least one analogized solenoid valve.

### BACKGROUND AND SUMMARY OF THE INVENTION

It is known that analogized solenoid valves, so-called AD (analog/digital) valves, are being increasingly used in ABS and/or ESP systems for motor vehicles for regulation of the hydraulic fluid. The coil current at which the AD valve opens is dependent on the pressure difference prevailing across the solenoid valve.

To be able to regulate AD valves, it is necessary to have precise information regarding the present wheel pressure and the TMC pressure of the tandem master cylinder (TMC). The TMC pressure is detected by means of a sensor.

A method for regulating a normally open solenoid valve in an analog mode is known from the generic WO 03/0537353, in which, to reduce valve noises during brake pressure regulation, the solenoid valve is switched into a partially open position which has a throttling action. To control the magnet coil such that it moves into said throttling position, it is proposed that said magnet coil be energized with fixedly set current values. At a first current value of zero, the solenoid valve is in the deenergized state, that is to say fully open; at a second current value, the solenoid valve is in the partially energized state and partially open for throttling purposes, and at a third current value, the solenoid valve is in the fully energized state, and thus fully closed. Furthermore, the spring characteristic curve of the valve spring of the solenoid valve should be configured such that, when the magnet coil is in the partially energized state, the valve body remains in the partially open position.

Such an inlet valve which is used in a brake system is operated in an analog mode, that is to say in the partially open state, in a state of equilibrium between magnet force, spring force and hydraulic forces.

The above described situation in accordance with a prior art example is shown in FIG. 5 in a detail illustration of a normally open solenoid valve 10, which solenoid valve is arranged in a valve block 11. Said solenoid valve 10 has a valve housing 3 with a magnet coil 1 which, when energized, moves an armature (not illustrated) which is operatively connected to a valve plunger 2, such that said valve plunger is moved in the direction of a valve seat 5 formed by a valve seat body 7, wherein, when the magnet coil 1 is fully energized, the valve body 5 closes off the opening of the valve seat 7 such that no hydraulic fluid can flow in via a pressure medium inlet duct 8 connected to a tandem high-pressure cylinder. When the solenoid valve 10 is open or partially open, hydraulic fluid flows, for the purpose of building up a pressure, into a wheel brake connected to a pressure medium outlet duct 9. The restoring force of the valve plunger 2 is generated by a valve spring 6.

The PWM-controlled magnet coil 1 generates a magnetic force which acts on the valve plunger 2 and which, in the partially open state, compensates the spring force and the hydraulic force which corresponds substantially to the difference between the TMC force and the brake pressure prevailing at the wheel, as a result of which a very sensitive equilibrium is established. The PWM control for attaining said equilibrium state is shown in the time-current diagram in FIG. 6, in which the current value I₁ of the closing current at which the solenoid valve 10 is held in the closed state is reduced to a current value I₂ of the working current I during the pulse time Tₚ of the PMW signal.

The quilibrium state exhibits stability only in a certain range. The width of said stable range is dependent on numerous operating parameters. Under limit conditions, hydraulic pressure oscillations from the brake system may cause the system to start to oscillate. This also incites high-frequency actuating variable variations in the current regulation, as a result of which valve noises are generated owing to oscillations of the valve plunger. Such a situation is shown by the measurement diagrams in FIG. 7, which shows, with respect to time, a pressure profile (FIG. 7a) in a connected wheel brake, the armature or plunger oscillation (FIG. 7b) and the profile of a coil current (FIG. 7c). In the diagram of FIG. 7c, the individual energization phases are clearly identifiable, in particular the partial energization phases Tₚ₁, Tₚ₂ and Tₚ₃ with a working current of current value I₂. During said partial energization phases Tₚ₁, Tₚ₂ and Tₚ₃, as can be seen in FIG. 7b, oscillating armature or plunger movements are generated which lead to high-frequency actuating variable variations, such that the pressure profile in FIG. 7a also oscillates in said partial energization phases Tₚ₁, Tₚ₂ and Tₚ₃.

The partial energization phases Tₚ₁, Tₚ₂ and Tₚ₃ are followed by a full energization phase with a current value at which the solenoid valve is closed; said current value is subsequently reduced to the current value I₁ of the closing current, as a result of which the solenoid valve is held in the closed state.

In the case of analog valves, it is attempted to attain a stable intermediate position of the valve plunger by means of equilibrium between the hydraulic force and the electrical magnetic force.

Here, however, there is the problem that, owing to the tolerance-afflicted actuation chain of analog valves, a precise pressure model is required in order to ensure a reproducible actuation of analog valves.

Here, the following influences must be taken into consideration in the establishment of such a pressure model:

wheel pressure,

TMC pressure,

TMC pressure gradient,

temperature,

pulse length,

precision of the set current,

dynamics of the current regulator,

brake line length,

system rigidity, and

quality of the control chain calibration.

An increased tendency toward the occurrence of valve oscillations exists in a brake system in particular at a low wheel pressure level with a low locking pressure level of less than 30 bar in combination with a high TMC pressure and high demanded analog volume flow rates.

In the case of pressure model errors or in the event of a displacement (wear) of the opening current characteristic curve, however, there is the risk of excessively high working currents being calculated, which can lead to an excessively low estimated volume flow rate. This has the result that the solenoid valve exhibits excessively high gradients and tends to build up an oscillation of the plunger. Under these limit conditions, hydraulic pressure oscillations from the brake system can cause the system to start to oscillate. As a result, high-frequency actuating variable variations are also incited in the current regulation, as a result of which noise-generating oscillations of the valve plunger are generated. Said noises are perceived in the vehicle as being highly unpleasant and disturbing, and result in a decrease in comfort.

It is the object of the invention to specify a method of the type mentioned in the introduction by means of which the occurrence of valve oscillations is prevented or at least substantially reduced, in order thereby to likewise minimize noises caused by oscillating valve plungers.

The object is achieved by means of a method in accordance with the present invention.

In the case of said method according to the invention for controlling the pressure in a hydraulic system, in particular in an electronically regulated brake system for a motor vehicle, in which method

the pressure or the pressure profile is controlled and/or regulated by means of at least one analogized solenoid valve,

to control and/or regulate the solenoid valve such that it moves into a partially open state, the coil current of the solenoid valve is modulated by alternation between a first and a second current value, and the solenoid valve is held in the closed state by means of a coil current corresponding to the first current value, it is provided according to the invention that

a third current value for the coil current is provided, wherein the third current value lies between the first and second current values and,

during that energization phase of the solenoid valve which is provided for energization with the second current value, the coil current is modulated by alternation between the second current value and the third current value with the amplitude predefined by the third current value and a predefined frequency.

Accordingly, the method according to the invention is characterized in that a stabilization of the valve plunger and a reduction in the oscillation tendency are attained by means of force modulation generated by current modulation in the magnet coil. Here, the frequency of the force modulation is dependent on the natural frequency of the solenoid valve used.

In one advantageous refinement of the invention, the current amplitude of the modulation, that is to say the third current value, is set as a function of the demanded volume flow rate through the solenoid valve.

The method according to the invention may advantageously be used both for normally open solenoid valves and also for normally closed solenoid valves, which are fully open and fully closed respectively when in the electrically deenergized state.

### BRIEF DESCRIPTION OF THE DRAWINGS

The method according to the invention will be explained and described in more detail below with reference to the appended figures, in which:

FIG. 1 shows a time-coil current diagram as an exemplary embodiment according to the invention of a modulated working current,

FIG. 2 shows measurement diagrams illustrating the reaction of the solenoid valve which is energized with the working current as per FIG. 1,

FIG. 3 shows a diagram illustrating the dependency of the amplitude of the modulated working current on the demanded volume flow rate,

FIG. 4 shows a wheel pressure-volume flow rate diagram illustrating the utilizable working range of a solenoid valve energized with the working current as per FIG. 1,

FIG. 5 shows a detail illustration of a normally open solenoid valve according to the prior art arranged in a valve block of a hydraulic unit,

FIG. 6 shows a time-current diagram illustrating an energization phase, known from the prior art, of a solenoid valve as per FIG. 5, and

FIG. 7 shows measurement diagrams illustrating the reaction of the solenoid valve as per FIG. 5 when energized with the working current as per FIG. 5.

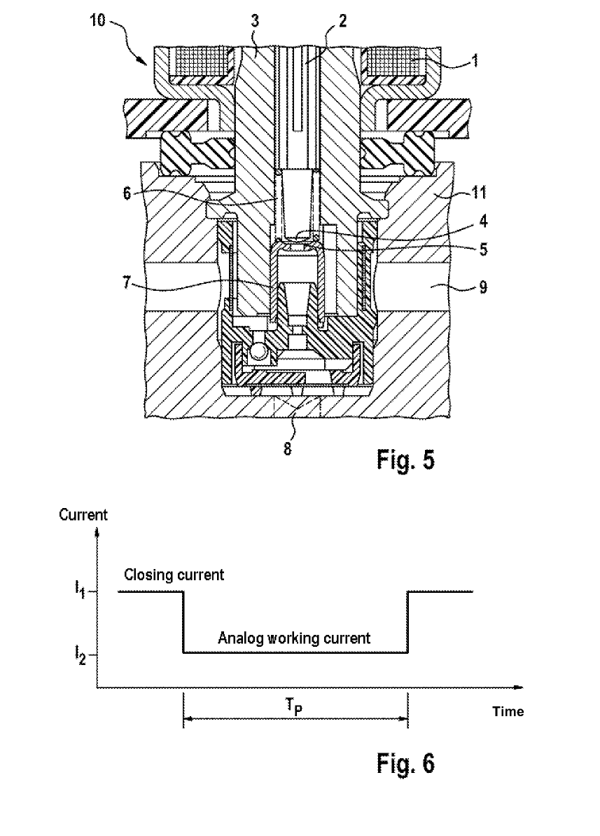

Below, the description relates to a normally open solenoid valve as per FIG. 5, as has already been described in the introductory part of the description.

### DETAILED DESCRIPTION OF THE INVENTION

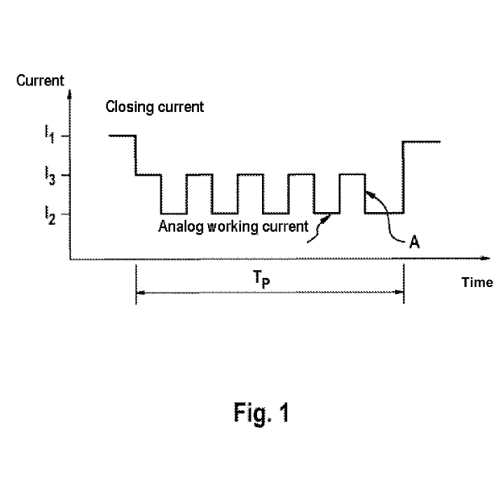

FIG. 1 shows an energization phase Tₚ according to the invention by means of which the solenoid valve 10 is controlled such that it moves into a partially open position. Before said energization phase Tₚ, the solenoid valve 10 is situated in its closed position, and in said position is energized by a coil current, referred to hereinafter as closing current, with a first current value I₁.

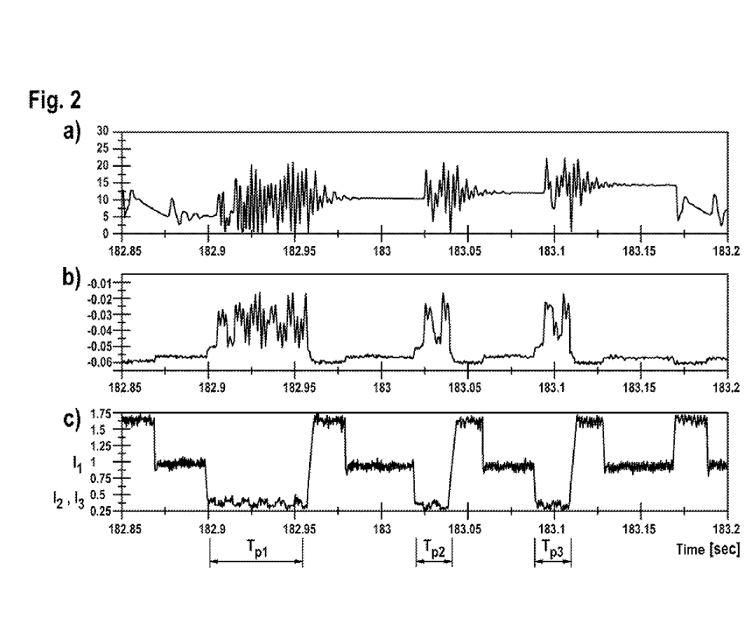

In the energization phase, the coil current is lowered to a first current value I₂, referred to hereinafter as working current, and is modulated at a predefined frequency with an amplitude A which leads to a third current value I₃. In this way, force modulation is generated in the solenoid valve 10, which force modulation leads to a modulation of the movement of the valve plunger 2 but without noise-generating oscillations, as illustrated in diagrams a) and c) as per FIG. 2.

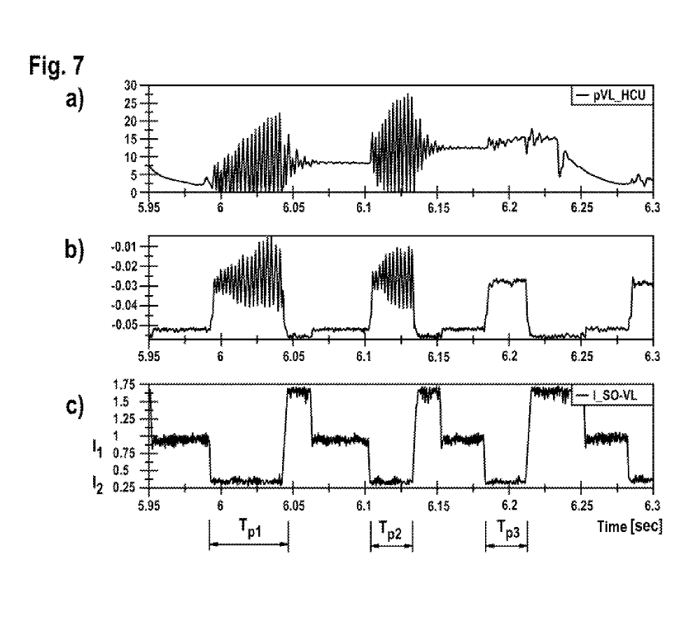

In FIG. 2, diagram a) shows three energization phases Tₚ₁, Tₚ₂ and Tₚ₃ each with a modulated working current illustrated correspondingly to FIG. 1. The adjacent energization phases correspond to those from the diagram of FIG. 7c).

Diagram b) of FIG. 2 shows the modulation movements generated by the modulated working current during the energization phases Tₚ₁, Tₚ₂ and Tₚ₃, but without the oscillations occurring as in FIG. 7b). Diagram a) of FIG. 2 shows the associated pressure profile in a wheel brake.

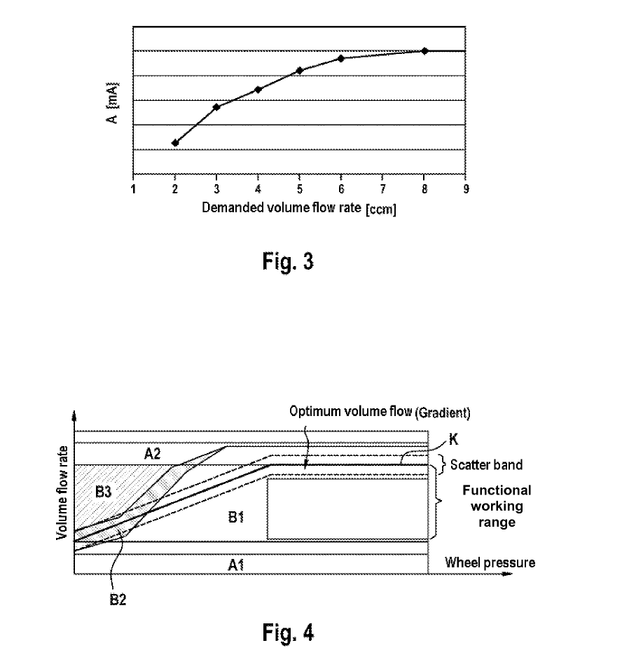

The amplitude A and the frequency of the current modulation of the working current are optimized by means of tests on a test stand, wherein according to FIG. 3, the amplitude A, that is to say that according to FIG. 1, corresponds to the difference between the third current value I₃ and the second current value I₂.

The wheel pressure volume flow diagram as per FIG. 4 shows the advantageous effect of the actuation according to the invention of a normally open solenoid valve. According to said diagram, there is a working range A1 which is non-utilizable owing to excessively low volume flow rates, and also a range A2 which is situated in the upper volume flow range and which is likewise utilizable only to a limited extent.

The functional working range that is actually utilizable is situated in between and is composed of a range B1, a range B2, and a range B3.

The range B1 constitutes a stable working range with regard to function and comfort which also exists in the case of normally open solenoid valves actuated in a known way as per FIG. 6 and in which no noise-generating oscillations occur.

If the solenoid valve 10 is energized as per FIG. 1, the range B2, which expands the range with regard to function and comfort, that is to say without noise generation, is additionally attained. The range B3 is only functionally robust, that is to say noise-generating oscillations may occur therein. It is thus possible to implement an optimum characteristic curve K, with a certain scatter band, which is optimum both with regard to function and also with regard to minimum noise generation.

While the above description constitutes the preferred embodiment of the present invention, it will be appreciated that the invention is susceptible to modification, variation, and change without departing from the proper scope and fair meaning of the accompanying claims.

1. A method for controlling the pressure in an electronically hydraulic regulated brake system for a motor vehicle, the method comprising the steps of:
controlling or regulating the pressure or the pressure profile in the brake system by means of providing at least one analogized solenoid valve (10),
controlling or regulating the solenoid valve (10) such that the valve moves into a partially open state, modulating the coil current (I) of the solenoid valve by alternation between a first current valve (I₁) and a second current value (I₂), and
holding the solenoid valve (10) is in a closed state by means of a coil current (I) corresponding to the first current value (I₁),
providing a third current value (I₃) for the coil current (I) wherein the third current value (I₃) lies between the first and second current values (I₁, I₂) and,
during energization phases (Tₚ₁, Tₚ₂, Tₚ₃) of the solenoid valve (10) which is provided for energization with the second current value (I₂), modulating the coil current (I) by alternation between the second current value (I₂) and the third current value (I₃) with the amplitude (A) predefined by the third current value (I₃) and at a predefined frequency.

2. The method as claimed in claim 1, further comprising the step of setting the third current value (I₃) as a function of the demanded volume flow rate through the solenoid valve (10).

3. The method as claimed in claim 1 further comprising the step of providing the solenoid valve (10) of a form in which the solenoid valve is fully open in the electrically deenergized state.

4. The method as claimed in claim 1 further comprising the step of providing the solenoid valve (10) of a form in which the solenoid valve is fully closed in the electrically deenergized state.
